(19) United States
(12) Patent Application Publication
(10) Pub. No.: US 2007/0011142 A1
(43) Pub. Date: Jan. 11, 2007

(54) Method and apparatus for non-redundant search results

(76) Inventors: Juergen Sattler, Wiesloch (DE); Joachim Gaffga, Wiesloch (DE)

Correspondence Address: KENYON & KENYON LLP, ONE BROADWAY, NEW YORK, NY, 10004, US

(21) Appl. No.: 11/176,122

(22) Filed: Jul. 6, 2005

(51) Int. Cl. G06F 17/30

(52) U.S. Cl. 707/3

(57) ABSTRACT

An apparatus and method for non-redundant search results includes performing a first search of local files to generate a plurality of first search result elements. This search is performed in response to a search request. The apparatus and method further includes performing a second search based on the search request. The second search may performed across a remote connection, such as a network connection, to search a remote database. The search of the remote database generates a plurality of second search result elements. The method and apparatus conforms the formatting of the second search result elements and the first search result elements. Thereupon, duplicative search results are culled between the first search result elements and the second search result elements. As such, the method and apparatus generates non-redundant search results by excluding the duplicative search results between the different databases.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to search engines and more specifically to improving search engine search results.

Desktop searching applications are generally well known and provide for retrieving specific information on a computing system. These searches readily provide specific information, but are limited in their usefulness based on the content to be searched.

In accordance with known operations, a user interface receives one or more search commands. Using these search commands, the elements on the computer are searched, such as using an SQL search. The search engine performs the searching using information associated with the file, such as the file names, file types, creation dates, modification dates or any other information.

These search engines also allow a user to select different searchable databases. In a networked computer, the search engine may search the local drive and one or more networked drives. Although, these search engines, regardless of the search location, still perform the search based on the general file information. The search engine typically does not perform the search based on content disposed within the files. Therefore, the search is limited to the information associated with the file.

Other search techniques are known that include searching data content, such as searching a whole computing system. In one technique, all data, including contents of the data objects, e.g. files, are searched based on the search terms. This search technique may allow the recovery of search objects generated by or reformatted by various applications. This search technique is limited by redundant search results, as discussed below, because the search engine locates duplicative search results.

Where a computer uses a standard desktop application in conjunction with interfacing a data processing application, the search engine is unable to search data associated with the data processing application. One current solution to this limitation is reformatting and locally saving data files. The local storage may be on the computer itself or any other accessible data storage location, such as a networked database, where local storage may be any accessible location outside of the data processing application.

The data files contain the information associated with the data processing application, but also contain additional information usable by the search engine. This information is also usable by other applications that may access the data and/or use the data for other processing operations. For example, if the data file includes information associated with a contract, the additional information may include the names of the parties to the contract, the date of the contract, the salesperson associated with the contract and any other suitable information.

If the contract in the data file has been accessed using an application associated with the desktop, there may also be a specific data file for this contract, in addition to the data processing application file. For example, using a word processing application can save a local copy of the document as well as a database copy. In another example, documents associated with the contract may be locally saved from attachments in electronic mail correspondents. This duplication creates problems for the search engine. When the search engine performs the search, the engine will then improperly list the duplicate data file, increasing the search results and requiring the user to decipher between which file is the intended search result file.

The problem of duplication further increases when the search engine has access to the data processing application. In a standard processing environment, the data processing application is remotely accessed and specific operations are performed both locally on the user's computing device and remotely on the server hosting the data processing application. While this local/remote relationship provides improved processing and increased functionality, the local computing system still performs local functions, such as offline data processing, data review and electronic communications. It is important to be able to have these data files accessible both locally and remotely. When the search engine performs the search function, there is duplication in the search results. The search engine may locate both the resident files and the data processing application files. The effectiveness of the search engine may therefore be reduced by producing redundant and duplicative search results.

### BRIEF DESCRIPTION OF THE DRAWINGS

FIG. 1 illustrates a block diagram of one embodiment of an apparatus for generating non-redundant search results;

FIG. 2 illustrates a block diagram of a processing environment for populating data files in a local database;

FIG. 3 illustrates a graphical representation of one embodiment of the method for generating non-redundant search results;

FIG. 4 illustrates the steps of one embodiment of a method for generating non-redundant search results; and

FIG. 5 illustrates the steps of another embodiment of a method for generating non-redundant search results.

### DETAILED DESCRIPTION

Using a search engine, the search results are filtered to eliminate any redundant search results. With the search engine performing multiple searches based on the location of the search, search results are compared with each other. In one example, after a first search is completed, the results of the second search are compared with the first search results before a resultant file or link of the second search result is accepted. Using this second level of comparison, redundant search results are eliminated, producing only non-redundant search results. In dealing with multiple searches across different platforms and in different environments, further steps are performed to provide non-redundancy of search results. The formatting of the different search result elements are conformed to provide a comparable list of search results, wherein the formatting includes possible manipulation of documents, data objects and/or the contents therein.

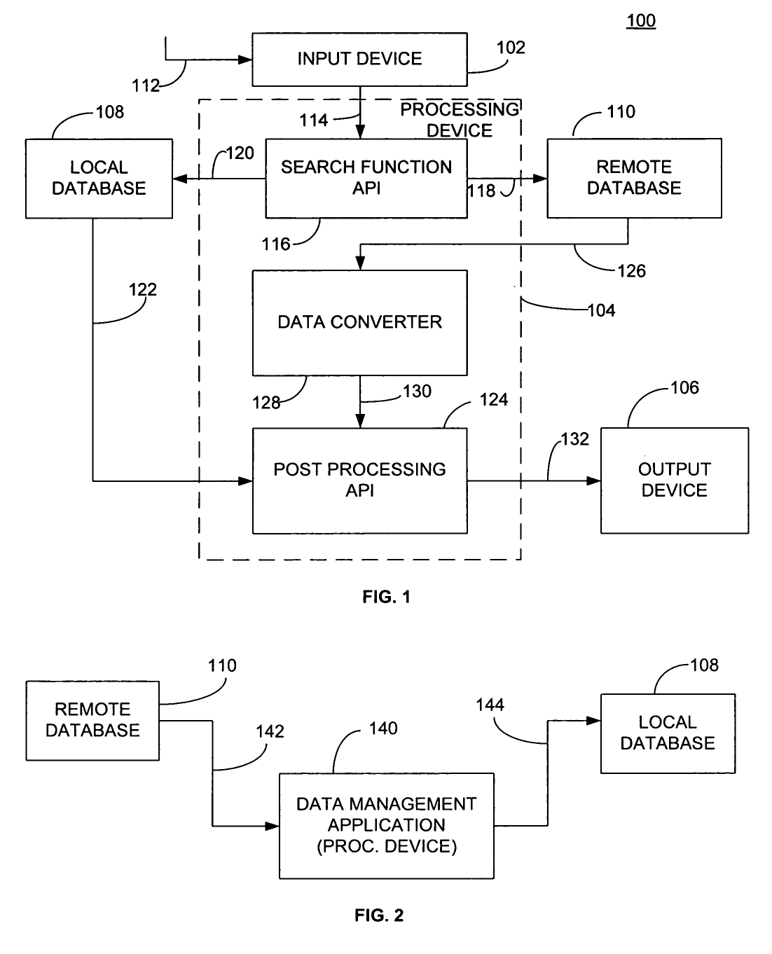

FIG. 1 illustrates an apparatus 100 for generating non-redundant search results. The apparatus includes an input device 102, a processing device 104 and an output device 106. Coupled to the processing device 104 are a local database 108 and a remote database 110. The input device 102 allows for the receipt of user input commands and the output device 106 provides for an output display of the resultant operations of the processing device 104. The databases 108 and 110 may be any suitable storage location allowing the storage and subsequent retrieval of data located therein.

As illustrated in FIG. 1, the input device 102 receives a user input 112. In one embodiment, the user input 112 may be provided using keystrokes on a keyboard in response to a visual display on the output device 106, prompting a user to enter a search term or a request for a search. The input device 102 converts the user input into a search request 114 that is provided processing device 104.

In one embodiment, the processing device 104 includes different processing modules, individually designated in FIG. 1. It is recognized there exists other elements and processing modules in the processing device 104, which have been omitted for clarity purposes only.

A search function API 116 receives the search request 114, which may include an encoded command for a search and one or more search terms and/or other search parameters, e.g. date filed created parameter. The search function API 116 provides a search command 118 to the remote database 110 and a search command 120 to the local database 108. In one embodiment, the search commands 118 and 120 may be the same command or may be different based on formatting specifications for the databases 108 and 110.

The local database 108 includes a plurality of local files stored therein. The remote database 110 includes a plurality of remote files stored therein. The local database 108 may be coupled to the processing device 104 across a local connection, such as an internal bus or other internal connection. The remote database 110 may be coupled to the processing device 104 across a network connection, such as an internet or web-based connection allowing for remote access therein. The remote database 110 may be associated with a networked application and is accessible through or based on this application. Whereas, in one embodiment, the search command 118 may include further elements associated with the networked remote aspect to the remote database 110, including commands associated with the underlying application or software platform.

Based on the search request 114, through the search function API 116, the local database 108 provides a plurality of first search result elements 122. These search result elements 122 include information associated with the underlying local files. In one embodiment, the search result elements 122 are descriptors of the underlying files and may include an active link to the storage location of the file itself. The search result elements 122 are provided to a post processing API 124 in the processing device 104 and temporarily maintained therein.

The remote database 110 also generates a list of search result elements 126 associated with the search results found in the remote database 110. Similarly to the search performed with the local database 108, the search results of the remote database 110 provide an indicator of files or other elements consistent with the terms of the search. The local search may be for files themselves, the content of the files, the other elements, such as an address or contact information, or may include content associated with these elements. These local files and elements may be in a wide variety of formats due to the varying manners in which the files and elements may be local stored. For example, the files may be extracted from an electronic communication and the elements may be extracted from the contents of one or more of the files. The formatting of the search result elements 126 is different than the format of the search result elements 122 because of the difference associated with the remote database 110 and the local database 108, as described in further detail below with respect to FIG. 2.

Based on these differences, the apparatus 100 insures non-redundant search results by conforming the formatting of these different search result elements 122 and 126. In one embodiment, a data converter 128 converts the formatting of the remote database search result elements 126 based on emulating a data file conversion process used by a data management application, as discussed below with respect to FIG. 2. In another embodiment, the files or elements may be manipulated using hidden data fields, for example meta data, associated with the local files, for example data fields indicating that a particular element is a business partner and that a particular file is a remotely generated word processing document. It is recognized by one having ordinary skill in the art that the local database search results 122 may also be readily converted to conform with the formatting associated with the remote database 110.

The conformed search result lists 130 are provided to the post processing API 124. In one embodiment, the API 124 culls duplicative search result elements between the local database search result elements 122 and the remote database search result elements 126. Once the redundant search results have been eliminated, a complete search list 132 is provided to the output device 106. In one embodiment, the output device 106 may be a video display displaying the file names of the search results. In another embodiment, the displayed file names may also include active links such that an end user may readily retrieve any one of the listed elements by clicking on the active link.

In one embodiment, when there were previously duplicative search result elements, the complete search list 132 may include an indication of the duplicative nature, indicating to the user that there is a resident file and a remote file. The active link may include a user-based selection to retrieve either the local file or the remote file. In another embodiment, an internal parameter may be set to dictate a remote file retrieval or local file retrieval.

Based on the searching being performed across different platforms, designated associated elements are used to compare different search results. In one embodiment, a file key is associated with each file that is replicated from the data processing application. In the replication process, which may including converting and writing data files to the computer desktop, the key is generated. This key may include any suitable information used to designate the file and the contents of the file. For example, in one embodiment, the key may be generated based on a numerical representation of elements associated with the content of the file.

With the integration of data processing applications being accessible and usable through a local computing device, such as laptop device, which are operated in both online and remote configurations, managing data is especially important. Often times, data is redundantly stored in multiple locations to allow the computing device to operate in a remote, or offline, mode. Where mobile computing devices cannot access the data processing application, the remote processing allows the continued benefit of using the data processing application. But this is often at the expense of redundant data files stored in multiple locations.

One technique to improve remote processing is to automatically load, or push, data processing files onto the remote computing device. This data push then allows a remote user access to a greater array of files. For example, if the data processing application is a business application and the user is a salesperson, the application may wish to push all the salesperson's associates' information and active sales agreements to the salesperson's laptop computer. Therefore, the salesperson, while on a sales call and not online with the business application, may still conduct the necessary business functions using the business application, such as generating a new contract and using the previous contract as a point of reference for renewal terms.

As mentioned before, this causes redundancy in files stored on the remote computing device. Therefore, the search engine, in running the search, would retrieve all of the redundant files, providing a user with a superfluous list of search results.

FIG. 2 illustrates an exemplary embodiment of how the local database 108 is populated with potentially duplicative data files from the remote database 110. A data management application 140, which may be executed by a processing device, such as the processing device 104 of FIG. 1, includes functionality to push remote database files 142 to become local files 144 stored in the local database 108.

For example, the data management application 140 may include automatically replicating and sometimes saving extra copies of the remote files 142 used by the data management application 140. In another embodiment, the application 140 may generate local versions of documents based on other applications or uses, such as converting contact information from a correspondence to a contacts list. For example, the locally saved information, such as a data element, may have a completely different format and/or appearance that the document or object from which the information was extracted.

The data management application 140 may be communication program, such as an electronic mail and calendar program that includes features associated with cataloging data files. When a local application, such as a word processing or database application retrieves a remote file 142 from the remote database 110, such as through a secured network communication, the data management application 140 may automatically generate and save a duplicate copy of the file. In another embodiment, the files may be pushed to the local database, as described above. In addition to numerous other benefits, this file-level redundancy provides user protection from lost data and also allows a user to utilize a document when not connected to the remote database.

When the data management application 140 saves the local files 144 to the local database 108, the application 140 includes different file naming techniques than the remote database 110. For example, in one embodiment, a file name may include different formatting to indicate when it was saved to the local database 108, that it is a local version instead of a network version, or other relevant features. Therefore, the file name and associated file information may be adjusted using specific parameters or settings dictated by the data management application, where the format of the file names of the local files 144 are different than the format of the remote files 142.

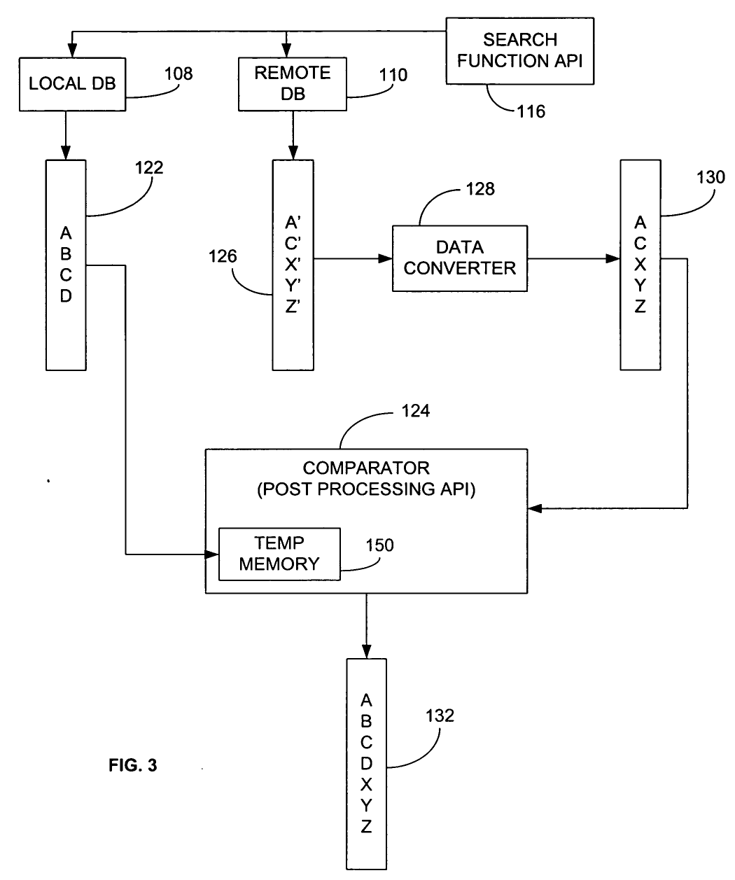

FIG. 3 illustrates a graphical representation of one embodiment of the present invention. The search function API 116 engages searching in both the local database 108 and the remote database 110. As discussed above, the local database generates local search results 122, which includes one more search result elements. For illustration purposes, the search results elements of the list 122 include elements A, B, C and D. These elements represent any suitable identification of subsequent data elements retrieved from the search of the local database 108. Similarly, the remote database 110 generates the remote search result list 126, which is illustrated to include fields A′, C′, X′, Y′ and Z′. These are illustrated having the naming nomenclature of “prime” to indicate that the format is different than the results 122.

As described above with respect to FIG. 1, the results 126 are provided to the data converter 128 which thereupon generates the format conforming to search result list 130. As illustrated, the data converter 128 converts A′ to A, B′ to B, X′ to X, Y′ to Y and Z′ to Z.

The local database search result elements 122 and the list 130 are provided to the comparator 124, referred to above in FIG. 1 as the post processing API. In one embodiment, the elements 122 are stored in a temporary buffer 150 associated with the comparator 124. The comparator 124 thereupon compares the elements 122 an the list 130 to cull duplicative search results. In the illustrated embodiment of FIG. 3, the complete search list 132 omits the duplicative A and C elements which were found both in the local database 108 and the remote database 110. thereupon providing non-redundant search results across the different databases 108 and 110.

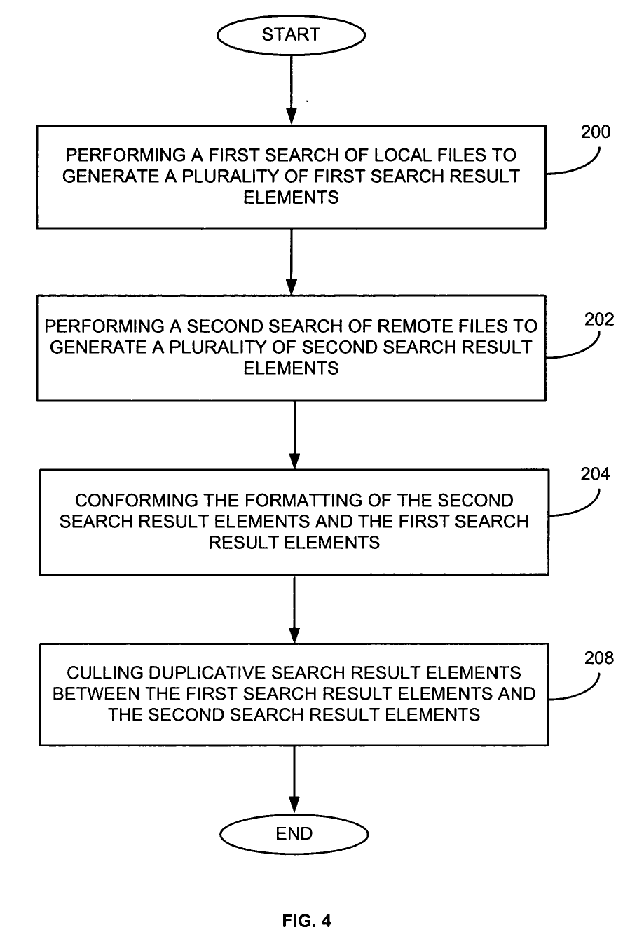

FIG. 4 illustrates the steps of one embodiment of a method for generating non-redundant search results. The method begins, step 200, by performing a first search of local files to generate a plurality of first search result elements. As discussed above, the first search may be performed using the local database 108 to retrieve the local database search result elements 122. The next step, step 202, is performing a second search of remote files to generate a plurality of second search result elements. Similarly as discussed above, this second search may be performed using the remote database 110 to generate the remote database search result list 126, where the remote database is accessed across a network. These searches may be performed after receiving a search request, such as discussed above with respect to FIG. 1, wherein the searching of steps 200 and 202 is performed based on this search request.

The next step, step 204, is conforming the formatting of the second search result elements and the first search result elements. This step may be performed by converting the first elements to a format consistent with the second elements, the second elements to a format consistent with the first elements, both elements to an independent format, or any other conversion as recognized by one having ordinary skill in the art. This step may include repeating file conversion or file naming procedures associated with a data management application, such as described above with respect to FIG. 2.

The next step, step 208, is culling duplicative search result elements between the first search result elements and the second search result elements. As illustrated above in FIG. 3, the complete search list 132 excludes the omitted duplicative results. In one embodiment, the step of culling may include comparing each of the plurality of second search result elements with each of the first search result elements. In this embodiment, the method is complete.

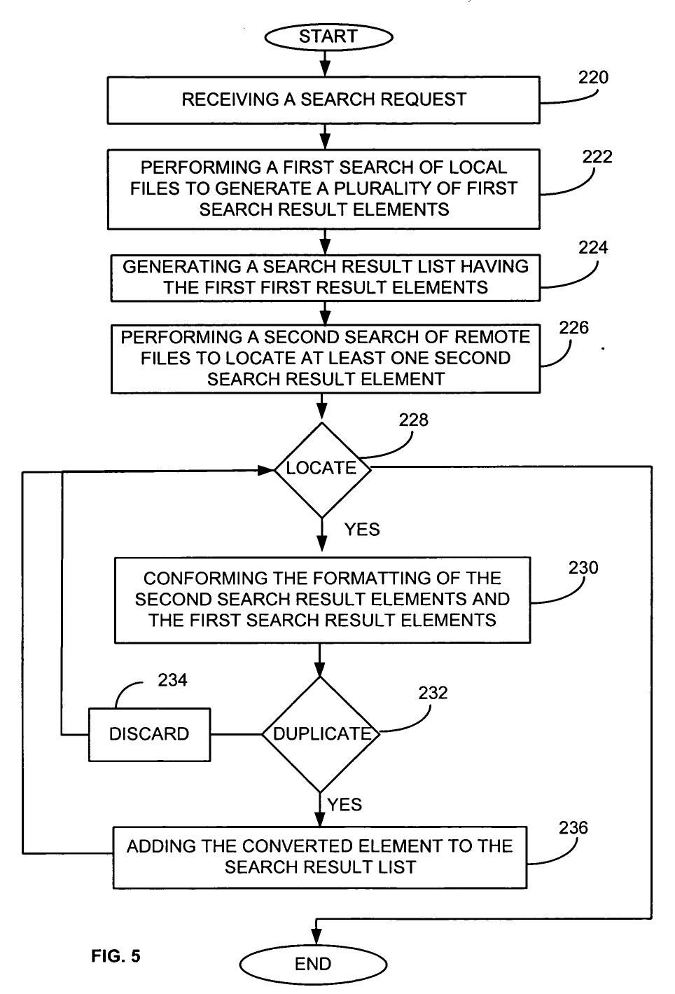

FIG. 5 illustrates another embodiment of a method for generating non-redundant search results. The method begins, step 220, by receiving a search request. As discussed above with respect to FIG. 1, this search request may be provided to the processing device 104 through the input device 102. The search request includes an identification of elements used for performing the search. The next step, step 222, is performing a first search of local files to generate a plurality of first search result elements, similar to step 200 of the method of FIG. 4. The next step, step 224, is generating a search result list having the first search result elements. This list may be any suitable list indicating the elements found in the first search, such as for example the illustrated list 122 in FIG. 3.

The next step is performing a second search of remote files to locate at least one second search result element, step 226. This step may be similar to step 202 of the method of FIG. 4, but differs based on the preceding actions upon locating a second search result element. The next step is determining a second search result element based on the search request, step 228. If an element is located, the method proceeds to step 230, wherein the method includes conforming the formatting of the second search result element and the first search result elements. In one embodiment, this step may be performed by converting the second search result element to becoming consistent with the formatting of the first search result elements.

The method thereupon proceeds to a determination of whether the second search result element is a duplicate of any one of the first search result elements, step 232. If the element is a duplicate, it is discarded, step 234. Although, if it is not a duplicate, thereby a non-redundant search result, the element is added to the search result list, step 236.

Regardless of whether the second search result is a duplicate or not, the method proceeds back to step 228. After the result is discard in step 234 or added to the search result list, in step 236, the method then determines if another search result element has been located. If yes, the method repeats steps 230 through 236 until the determination at step 228 is no. When the answer to step 228 is in the negative, this embodiment of the method is complete.

As such, file searching can be performed in processing environments having a data management application locally storing duplicative data files from a remote database. Using the process device, redundant search results are culled from a completed search list so that the user is provided a visual display of the non-redundant search results. In one embodiment, the visual display even includes active links to allow a user to directly access the particular file, further improving the usability of a search feature. The system may thereupon continue to maintain locally stored data files without sacrificing the effectiveness of a search feature for user functionality.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exist implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. An apparatus for generating non-redundant search results comprising:
a local database storing a plurality of local files;
a remote database storing a plurality of remote files; and
a processing device, in operative communication with the local and remote databases, the processing device operative to, in response to executable instructions:
perform a first search of the local files to generate a plurality of first search result elements;
perform a second search of the remote files to generate a plurality of second search result elements;
conform the formatting of the second search result elements and the first search result elements; and
cull duplicative search result elements between the first search result elements and the second search result elements.

2. The apparatus of claim 1, wherein the processing device culls duplicative search results by comparing each of the plurality of second search result elements with the plurality of first search result elements.

3. The apparatus of claim 1 further comprising:
an input device; and
the processing device coupled to the input device, wherein the processing device is operative to:
prior to performing the first search, receive a search request from the input device such that the first search and the second search are based on the search request.

4. The apparatus claim 3 wherein the local database includes data files from the remote database, the local files converted by a data management application.

5. The apparatus of claim 4 wherein the processor is coupled to the remote database across a network.

6. The apparatus of claim 3 further comprising:
an output device; and
the processing device coupled to the output device such that processing device is operative to:
generate a complete search result list; and
provide the search result list to the output device, wherein the search result list includes an active link for each of the search result elements of the list.

7. The apparatus of claim 1, wherein the processing device is operative to perform the executable steps of converting the second search result elements and culling duplicative search result elements each time one of the plurality of second search result elements is generated.

8. A method for generating non-redundant search results comprising:
performing a first search of local files to generate a plurality of first search result elements;
performing a second search of remote files to generate a plurality of second search result elements;
conforming the formatting of the second search result elements and the first search result elements; and
culling duplicative search result elements between the first search result elements and the second search result elements.

9. The method of claim 8 wherein the step of culling duplicative search results includes comparing each of the plurality of second search result elements with the plurality of first search result elements.

10. The method of claim 8 further comprising:
prior to performing the first search, receiving a search request; and
performing the first search and the second search based on the search request.

11. The method of claim 8 further comprising:
performing the first search in at least one local database; and
performing the second search in at least one remote database.

12. The method of claim 11 wherein the local database includes data files from the remote database, the local files converted by a data management application.

13. The method of claim 12 further comprising:
accessing the remote database across a network.

14. The method of claim 13 further comprising:
generating an active link for each of the search result elements.

15. The method of claim 9, wherein the steps of converting and culling are performed each time one of the plurality of second search result elements is generated.

16. A method for generating non-redundant search results comprising:
performing a first search of local files in at least one local database to generate a plurality of first search result elements;
generating a search result list having the first search result elements;
performing a second search of remote files in a remote database to locate at least one second search result element; and
upon locating a second search result element:
conforming the formatting of the second search result element and the first search result elements;
comparing the second search result element with the search result list; and
adding the second search result element to the search result list if it is not the same as any of the first search result elements.

17. The method of claim 16 further comprising:
prior to performing the first search, receiving a search request; and
performing the first search and the second search based on the search request.

18. The method of claim 16 wherein the local database includes data files from the remote database, the local files converted by a data management application.

19. The method of claim 18 further comprising:
accessing the remote database across a network.
